(19) United States
(12) Patent Application Publication
(10) Pub. No.: US 2001/0037511 A1
(43) Pub. Date: Nov. 1, 2001

(54) Program recording and distributing system, program recording and distributing method, and recording medium for recording a recording and distributing program

(75) Inventor: Koichi Inagaki, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/840,030

(22) Filed: Apr. 24, 2001

(30) Foreign Application Priority Data
Apr. 26, 2000 (JP) 2000-126528

(51) Int. Cl. H04N 7/173

(52) U.S. Cl. 725/115; 725/114; 725/109

(57) ABSTRACT

The present invention provides a program recording and distributing system, a program recording and distributing method, and a recording medium that stores a program recording and distributing program. A server 3 stores in a recording DB7 a plurality of program data received via either a communication line or a broadcast line from a broadcast station 120, receives distribution application data for a program broadcast from a broadcast station 120, carried out a registration process, stores this as distribution registration data in the automatic timed recording DB 6, and distributes via wither a communication line 100 or the Internet 1 the program data stored in the recording DB7 based on the distribution registration data stored in the automatic times recording DB6.

### BACKGROUND OF THE INVENTION

1. Field of the Invention

The present invention relates to a distribution system for television programs and the like, and in particular to a program recording and distributing system, a program recording and distributing method, and a recording medium for recording a program recording and distributing program.

2. Description of the Related Art

In recent years, due to the spread of the video tape recorder (VTR), individuals record broadcast television programs and view these programs at a desired time on a daily basis. In addition, if an automatic timed recording function is added to the VTR and the program to be recorded is set using this automatic timed recording function, then program recording can be carried out without having to operate the VTR at the time this program is broadcast. Therefore, if individuals use this automatic timed recording function of the VTR, there is no need to be at a household having a VTR at the time that the program to be seen is broadcast.

However, in the conventional program recording method described above, in the case that the individual goes outdoors without setting the automatic timed recording for the program to be seen, naturally, the program is not recorded by the VTR. In addition, the automatic timed recording is carried out by indicating the recording times, and thus even in the case that an automatic timed recording is made, in the case that the broadcast program is not broadcast at the scheduled broadcast time, the desired program will not be recorded.

In addition, the broadcast station of the television program reruns programs already broadcast, but programs that are rerun are limited to programs having high viewer ratings, and there is no guarantee that the individuals will have an opportunity to view programs that they wanted to see.

### SUMMARY OF THE INVENTION

In consideration of the problems described above, an object of the present invention is to provide a program recording and distributing system, program recording and distributing method, and recording medium for storing a program recording and distributing program that can guarantee to individuals an opportunity to view a desired program.

In order to attain the above-described object, a first aspect of the invention provides a first storage device that stores a plurality of program data to be distributed to a client, a second storing device that stores a plurality of distribution registration data, which is the distribution information for program data, stored in the first storage device, and a server that carries out a recording process that receives the program data via a communication line or a broadcast line from a broadcast station and stores it in the first storage device, a distribution registration process that receives the distribution application data for a program sent from the broadcast station via a communication device from the client terminal, carries out distribution registration, and stores this in the second storage device as distribution registration data, and a distribution process that distributes the program data stored in the first storage device via a communication device based on distribution registration data stored in the second storage device.

A second aspect of the invention provides a first storage device that stores a plurality of recording registration data, which is the recording information of the program data, distributed to a client, a second storing device that stores a plurality program data, a third storage device that stores a plurality of distribution registration data, which is the distribution information for program data, stored in the second storage device, and a server that carries out a recording registration process that receives the program recording application data sent from the broadcast station via a communication device from a client terminal, carries out a registration process, and stores this in the first storage device as recording registration data, a recording process that receives the program data from the broadcast station via either a communication line or a broadcast line and stores the received program data in the second storage device based on the recording registration data stored in the first storage device, a distribution registration process that receives program distribution data via a communication device from a client terminal, carries out a registration process, and stores this in the third storage device as distribution registration data, and a distribution process in which the program data stored in the second storage device is distributed via a communication device based on the distribution registration data stored in the third storage device.

A third aspect of the invention according to the first and second aspects wherein the server associates and stores the storage time and program name when the program data is stored in the recording process.

A fourth aspect of the invention according to the first through third aspects wherein the server periodically distributes program data stored in the distribution process.

A fifth aspect of the invention of a program recording and distribution system in a server that records and distributes programs broadcast from a broadcast station, including a program recording and distribution method comprising a step of storing in the first storage device a plurality of program data received via either a communication line or broadcast line from a broadcast station, a step of receiving distribution application data for a program via a communication device from a client terminal and carrying out a registration process, and storing this in the second storage device as distribution registration data, and a step of distributing via a communication device program data stored in the first storage device based on the distribution registration data stored in the second storage device.

A sixth aspect of the invention of a program recording and distribution method in a server that records and distributes programs broadcast from a broadcast station includes a program recording and distributing method comprising a step of receiving program recording application data via a communication device from a client terminal, carrying out a registration process, and storing this in the first storage means as recording registration data, a step of receiving program data via either a communication line or a broadcast line from a broadcast station and storing this received program data in the second storage device based on recording registration data stored in the first storage device, a step of receiving distribution application data for a program via a communication device from a client terminal, carrying out a registration process, and storing this in the third storage device as distribution registration data, and a step of distributing via a communication device program data stored in the second storage device based on the distribution registration data stored in the third storage device.

A seventh aspect of the invention comprises a step of recording a plurality of programs broadcast from a broadcast station, a step of receiving a distribution application for a program from a client, a step of registering the received distribution applications as distribution information, and a step of distributing recorded programs based on the registered distribution information.

An eighth aspect of the invention comprises a step of receiving from a clients recording applications for programs broadcast from broadcast stations, a step of registering the received recording applications as recording information, a step of recording programs based on the registered recording information, a step of receiving distribution application for a program from a client, a step of registering the received distribution applications as distribution information, and a step of distributing recorded programs based on registered distribution information.

A ninth aspect of the invention in a computer readable recording medium that stores a program recording and distributing program for carrying out program recording and a distribution process in a server that records and distributes broadcast programs from a broadcast station, a program recording and distribution program executes on a computer a process for storing in a first storage device a plurality of program data via either a communication line or a broadcast line from a broadcast station, a process for receiving distribution application for a program data via a communication device from a client terminal, carrying out a registration process, and storing this in the second storage device as distribution registration data, and a process for distributing via a communication device program data stored in the first storage means based on the distribution registration data stored in the second storage device.

A tenth aspect of the invention in a computer readable recording medium that stores a program recording and distributing program for carrying out program recording and a distribution process in a server that records and distributes broadcast programs from a broadcast station, a program recording and distribution program executes on a computer a process for receiving program recording application data via a communication device from a client terminal, carrying out a registration process, and storing this in the first storage device as recording registration data, a process for receiving program data via a communication line or a broadcast line from a broadcast station and storing this received program data in the second storage device based on the recording registration data stored in the first storage device, a process for receiving distribution application data for a program via a communication device from a client terminal, carrying out a registration process, and storing this in the third storage device as distribution registration data, and a process for distributing via a communication device program data stored in the second storage device based on the distribution registration data stored in the third storage device.

Thereby, the above-described program recording and distribution system can be realized by using a computer.

### BRIEF DESCRIPTION OF THE DRAWINGS

FIG. 1 is a block diagram showing the structure of the program recording and distributing system according to an embodiment of the present invention.

FIG. 2 is a flowchart showing the flow of the program distribution process carried out by the server shown in FIG. 1.

FIG. 3 is a sequence diagram showing the flow of a program recording and distributing process in the first embodiment of the present invention.

FIG. 4 is a sequence diagram showing the flow of a program recording and distributing process in the second embodiment of the present invention.

### DETAILED DESCRIPTION OF THE INVENTION

Below, the embodiments of the present invention will be explained referring to the drawings.

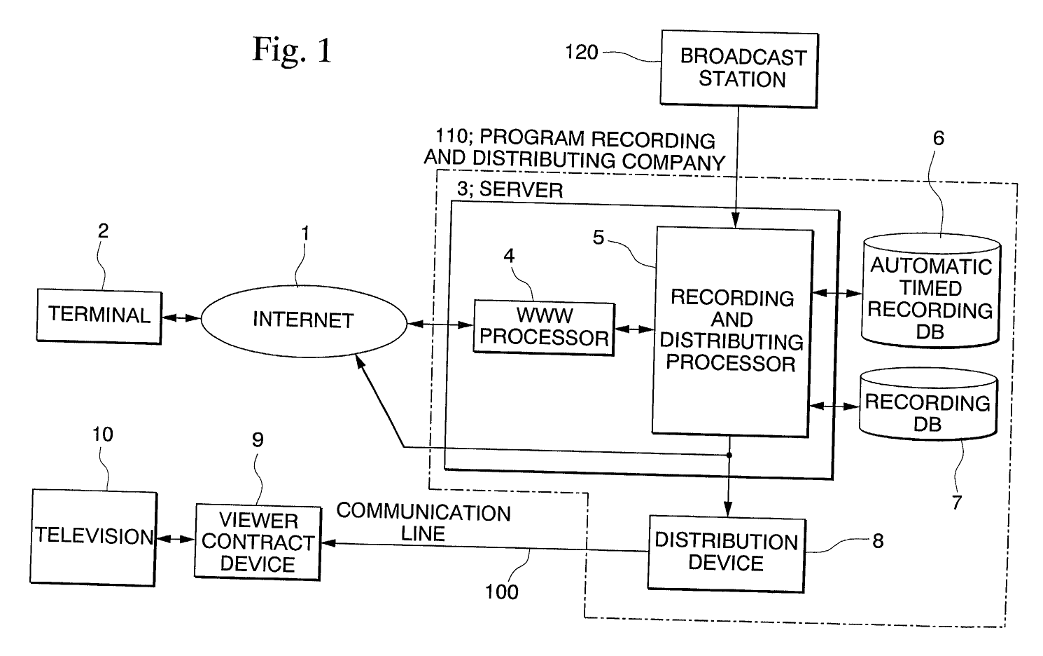

FIG. 1 is a block diagram showing the structure of the program recording and distributing system according to an embodiment of the present invention. First, referring to this drawing, the structure of the program recording and distributing system according to the first embodiment of the present invention will be explained.

In FIG. 1, reference numeral 1 is the Internet, which is a computer network; reference numeral 2 is a terminal (client terminal) such as the dedicated terminal of a desk top personal computer, or a mobile terminal such as a note-type personal computer, a portable terminal, or a mobile telephone having a simple Internet connection called i-mode, that is connected to the Internet 1 via a communication line; reference numeral 110 is a program recording and distributing company that receives and records the programs broadcast by the broadcast station 120 of the television program, and distributes these recorded programs via either a communication line 100 or the Internet 1 connected as a communication device based on a distribution application received via the communication device from a plurality of contracting clients; reference numeral 9 a viewer contract apparatus that receives the distributed program from the program recording and distributing company 110 via a connected communication line, and in addition, carries out authentication of the viewer contract with the program recording and distributing company 110; and reference numeral 10 is a television that is connected to the viewer contract apparatus 9 for viewing the programs received by the viewer contract apparatus 9.

Moreover, the viewing contract apparatus 9 can be connected to the video tape recorder (VTC), and the program received by the viewer contract apparatus 9 can be recorded.

Moreover, the reception of broadcast programs of the broadcast station 120 carried out by the program recording and distributing company 110 is carried out via a communication device, such as either a subscriber line or a broadcast line used for the broadcast.

Moreover, in the first embodiment shown in FIG. 1 described above, a plurality of client viewer contract apparatuses 9 (not illustrated) are connected to the program recording and distributing company 110 via a communication line 100, and in addition, a plurality of client terminals 2 (not illustrated) are connected via the Internet 1.

In the program recording and distributing company 110 shown in FIG. 1, reference numeral 6 is an automatic timed recording database (hereinafter, abbreviated “automatic timed recording DB”) that provides a distribution table that registers the distribution information such as distribution destination, distribution day and time, distribution method, and distributed program based on the distribution applications from the plurality of clients, reference numeral 7 is a recording database (hereinafter, abbreviated “recording DB”) that stores the program data of the plurality of programs received from the broadcast station 120, reference numeral 3 is a server comprising a WWW (World Wide Web) processor 4 that is connected to the Internet 1, displays home pages for program recording and distributing applications to the plurality of terminals 2 connected via the Internet 1 and carries out reception of the distribution application data sent from each of the terminals 2 based on the home page for displayed program recording and distribution application and transmission of the registration completion notification data to each of the terminals 2, and a recording and distribution processor 5 that receives program data for programs broadcast from the broadcast station 120 and records it in the recording DB 7, carries out a registration process to register in the distribution table of the automatic timed recording DB 6 the distribution application data received from the WWW processor 4, and, based on the distribution registration data registered in this distribution table, reads the program data recorded in the recording DB 7 and distributes by a distribution method via either a communication line 100 or the Internet 1, and carries out an accounting process with the client to whom the programs are distributed, and reference numeral 8 is a distribution apparatus that distributes program data input from the recording and distribution processor 5 via a communication line 100 based on the distribution instructions from this recording and distribution processor 5.

This distribution apparatus 8 transmits the program data to each of the viewer contract apparatuses 9 by using a plurality of multiplexed distribution channels on the communication line 100. In addition, the recording and distribution processor 5 carries out registration of allotment on this distribution for each of the channels of the distribution apparatus 8 in the case that this distribution method is a communication line 100 during recording of the distribution table stored in the automatic timed recording DB.

Moreover, the storage capacity of the recording DB 7 is a predetermined capacity, for example, the amount that can store all of the broadcast programs for eight days, and records and updates the program data received from the broadcast station 120 in an order according to the first in, first out method. Therefore, in the recording DB 7, excluding the program data being received and stored, one week of program data before the received date is stored.

In addition, in the automatic timed recording DB 6, a predetermined interval, for example, a 15 day broadcast program schedule for the broadcast station 120 including about one week is stored in advance by the recording and distribution processor 5, and stored and updated in a sequence by the first in, first out method. Furthermore, in the automatic timed recording DB 6, the customer data of a plurality of clients that have completed a program recording and distributing contract is stored in advance by recording and distribution processor 5.

Moreover, the automatic timed recording DB 6 and the recording DB 7 are formed by a hard disc apparatus and opto-magnetic disc apparatus, nonvolatile memory such as flash memory, a recording medium that can read a CR-ROM and the like, a volatile memory such as RAM (Random Access Memory), or a combination thereof. In addition, even when the automatic timed recording DB 6 and the recording DB 7 are build into the server 3, the server 3 can access the automatic timed recording DB 6 and the recording DB 7 by communications in another apparatus (database server).

Moreover, the WWW processor 4 and the recording and distributing processor 5 can be realized by dedicated hardware, and in addition, the WWW processor 4 and the recording and distributing processor 5 are formed by memory and a CPU (central processing unit), and the functions can be realized by loading into memory and executing a program for realizing each of the functions of the WWW processor 4 and the recording and distribution processor 5.

In addition, an input apparatus, a display apparatus and the like (not illustrated) are connected to the server 3 as peripheral devices. Here, the input apparatus can be an input device such as a keyboard or a mouse. The display apparatus can be a CRT (cathode ray tube), a crystal liquid display, and the like.

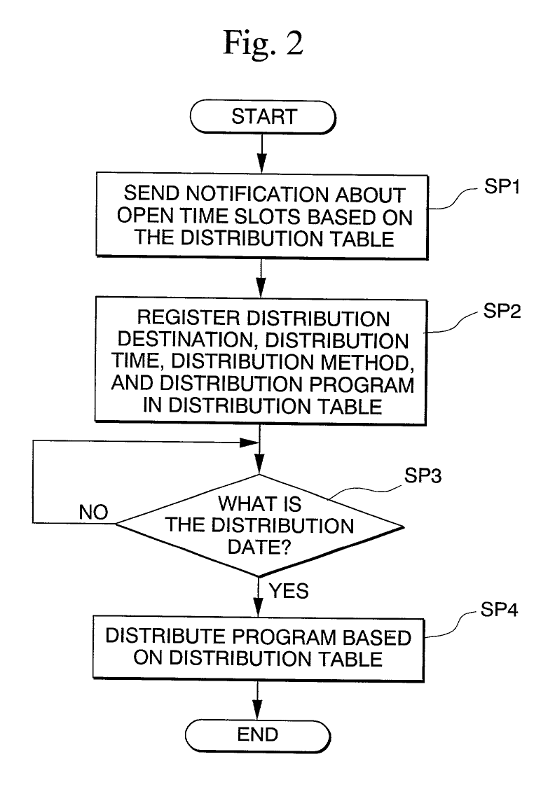

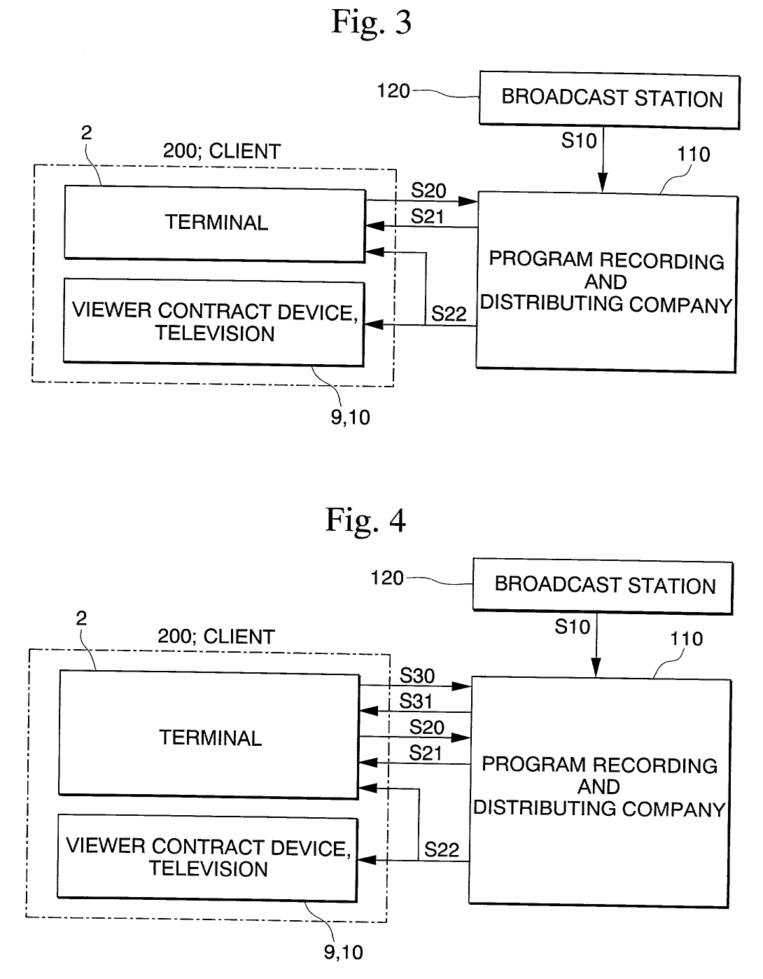

Next, referring to FIG. 2 and FIG. 3, the operation of the program recording and distributing system according to the first embodiment described above. FIG. 2 is a flowchart showing the flow of the program distributing process carried out by the recording and distributing processor 5 in the server 3 shown in FIG. 1. FIG. 3 is a sequence diagram showing the flow of the program recording and distributing process according to the first embodiment described above.

First, the program recording process in the program recording and distributing process according to the first embodiment described above will be explained referring to FIG. 3. First, the program recording and distributing company 110 receives the program data S 10 broadcast from the broadcast station 120 based on the contracts with the broadcast station 120, and records the program data S 10 in the recording DB 7. While storing this in this recording DB 7, the recording and distributing processor 5 associates the recording time and the program name of the program data S 10 that is stored, and stores this in the recording DB 7. By this association between the recording time and the program name, even if the distribution application from the client is made by the program name, the relevant program data can be read from the recording DB 7.

Moreover, in the case that the broadcast time for any program broadcast from the broadcast station 120 is different from the time of the announced broadcast program schedule recorded in the automatic timed recording DB 6, the recording and distributing processor 5 is notified about the actual broadcast times by the broadcast station 120, and based on this notification about the actual broadcast time, it associates the stored time and broadcast name.

Next, the program distribution process in the recording and distributing process according to the first embodiment described above will be explained referring to FIG. 2 and FIG. 3. First, the program recording and distributing company 110 receives broadcast distribution applications based on contracts with the clients 200. When an application for program distribution is received, the WWW processor 4 displays in advance on the terminal 2 of the client 200 the home page for the program recording and distribution application. The broadcast program schedule of the broadcast station 120 for that day or for about one week is read from the automatic timed recording DB 6 by the WWW processor 4 and displays it on the home page for the program recording and distribution application. The client 200 selects the desired program from the broadcast program schedule that is shown, and carried out the distribution application S 20 for the selected program by indicating the distribution day and the distribution method which can be either distribution to the viewer contract apparatus 9 via a communication line 100 or distribution to the terminal 2 via the internet. By this distribution application S 20, the distribution day, distribution method, distributed program name, and the identification number of the client 200 are sent to the WWW processor 4 via the Internet 1 from the terminal 2 as distribution application data.

First, when the WWW processor 4 receives the distribution application data of the distribution application S 20 of the client 200 from the terminal 2, the recording and distributing processor 5 is notified. Next, the recording and distributing processor 5 finds whether or not the identification number in the distribution application data notification is recorded in the customer data recorded in the automatic times recording DB 6 in order to authenticate that the client 200 who is the applicant of this distribution application S 20 is a regular client, and in the case that the applicant is not registered, sends a notification to the applicant via the WWW processor 4 stating that reception of the distribution application is not possible to the terminal 2. In contrast, if the applicant is a registered client, the recording and distribution processor 5 can authenticate the client 200, and then in the case that the distribution method is via a communication line 100, searches for an open distribution time slot on the desired distribution date on each distribution channel from a distribution table stored in the automatic timed recording DB 6, and notifies the terminal 2 via the WWW processor 4 about the open time slot (step SP 1). Moreover, in the case that the distribution method is via the Internet 1, the terminal 2 is notified that the open time slot is an entire day.

Next, when the recording and distribution processor 5 is notified from the terminal 2 via the WWW processor 4 about the distribution time that has been selected from the open time slots, the distribution time, distribution destination, distribution day, distribution method, and distribution program name are registered in the distribution channel allotted to this distribution and the distribution table, and a notification about registration completion S 21 for the distribution application S 20 is sent to the terminal 2 (step SP 2).

Next, when the distribution time registered in the distribution table arrives, the recording and distributing processor 5 reads the relevant program data S 22 from the recording DB 7, and based on the distribution information in this distribution table, distributes it by the appropriate distribution method to the client 200, who is the appropriate distribution destination (steps SP 3 and SP 4). Next, the recording and distributing processor 5 carries out an accounting process for the client 200.

Moreover, in the distribution application from the client 200, program data to be distributes can be indicated by a broadcast date instruction rather than by a program instruction, as described above.

In the first embodiment described above, the programs that are recorded in advance are distributes based on the distribution application from the client, and thus the opportunity for viewing the desired program can be guaranteed for each client (each individual).

Moreover, in the first embodiment described above, the recording and distributing processor 5 can also distribute the program data for all programs stored in the recording DB 7 at a broadcast day unit using one of the distribution channels among the plurality of multiplexed distribution channels on a communication line 100, and each client can select and view the desired program on a pay per view basis using the viewer contract apparatus 9. For example, the recording and distributing processor 5 can simultaneously distribute over the seven distribution channels the programs for each broadcast day using the program data of the past week stored in the recording DB 7. This means that over one distribution channel, the programs from the previous day are distributed, or over another channel, the programs broadcast two days previously are distributed, and thus programs from the past week are continuously distributed. Therefore, by using the above-described distribution by distribution application and this constant distribution, for each client viewing opportunities for the desired programs can be more reliably guaranteed.

Next, FIG. 4 is a sequence diagram showing the flow of the program recording and distribution process according to the second embodiment of the present invention. Moreover, in the program recording and distribution system according to the embodiment of the present invention shown in FIG. 1, the second embodiment differs from the first embodiment on the points that a recording table that stores a plurality of recording registration data registered as recording information in the automatic timed recording DB 6 is provided, and that recording and distributing processor 5 stores the program data received from the broadcast station 120 in the recording DB 7 based on the recording registered data in this recording table. Below, the operation of the elements of the second embodiment that differ from the first embodiment will be explained.

In the program recording process in the program recording and distributing process according to the second embodiment shown in FIG. 4, like the first embodiment described above, first the client 200 selects the desired program from the broadcast program schedule of the home page for the program recording and distributing application shown on the terminal 2, and sends a notification about the recording application S 30. The recording and distribution processor 5 of the server 3 that receives this recording application S 30 verifies that the application is from a regular client 200, and then registers the program application data of this recording application S 30 in the recording table stored n the automatic timed recording DB 6. Next, the recording and distributing processor 5 notifies the terminal 2 about the registration completion S 31 for the recording application S 30, and stores the program data sent from the broadcast station 120 in recording DB 7 based on the recording registration data of the recording table stored in the automatic timed recording DB 6.

Moreover, the program distribution process in the recording and distribution process according to the second embodiment shown in FIG. 4 is the same as that in the above-described first embodiment.

In the case that the number of clients who are the object of distribution is small, the program recording and distributing process according to this second embodiment is effective in reducing the storage capacity of the recording DB 7.

Moreover, in the embodiment described above, the program recording and distribution company 110 was structured such that the broadcast program is received from the broadcast station 120 and recorded, but it can also receive and record broadcast programs from a plurality of broadcast stations.

Moreover, the embodiment described above is structured such that the server 3, the automatic timed recording DB 6, and the recording DB 7 are provided at the program recording and distributing company 110, but these can be provided at the broadcast station 120, and the broadcast company 120 can carry out the program recording and distribution process described above.

Moreover, the embodiment described above is structured such that the program recording and distributing system receives recording applications and distribution applications for programs via the Internet 1, but the communication device for recording application or distribution application is not limited to a computer network such as the Internet, but can be a communication device that uses a communication line such as a telephone or facsimile, or a communication device using the mail, such as a letter.

Moreover, the embodiment described above is structured such that the program recording and distributing system distributes programs via either a communication line 100 or the Internet, which are communication device, but the distribution device for programs is not limited to a communication device, and the distributed program can be recorded on a recording medium such as a video tape or DVD (Digital Video Disc), and the recording medium having this distributed program recorded thereon can be distributed by a distribution device such as the mail or package delivery.

In addition, in the embodiment described above, the program for realizing each of the processes carried out by the server 3 shown in FIG. 1 is recorded on a computer readable recording medium, the program recorded on this recording medium is read into a computer system, and this program recording and distributing system carried out from there. Moreover, what is referred to here as a “computer system” includes the OS and hardware such as peripheral devices.

In addition, the term “computer system” includes a home page providing environment (or display environment) in the case that the WWW system is used.

In addition, the term “computer readable recording medium” denotes portable media such as floppy discs, magneto-optical discs, ROMs, and CD-ROMs, and storage apparatuses such as hard discs built into the computer systems.

Furthermore, the term “computer readable recording media” includes temporary program storage, for example, as networks such as the Internet, the servers that send programs via a communication line such as a telephone line, and volatile memory (RAM) in the client computer system.

In addition, the above-described program can be sent from the computer system storing this program in a storage apparatus to another computer system by a transmission medium or by transmission waves in a transmission medium. Here, “transmission media” denotes media having the function of transmitting information such as a network (communication network) and a communication line (communication wiring) such as a telephone line.

In addition, the above-described program can be for realizing one part of the above-described functions. Furthermore, this program can take the form of what is called a distributed file (distributed program) that realizes the above-described functions by a combination of programs already recorded in the computer system.

Moreover, the embodiment described above is structured such that the program recording and distributing system carries out a program recording and distributing process for television programs, but the recorded and distributed programs are not limited to television programs, but can also be radio broadcast programs or text broadcast programs. Moreover, in the case of radio broadcasts, the recording process in the embodiment described above carries out audio recording process.

Above, the embodiments of the present invention were explained in detail referring to the figures, but the concrete structure is not limited by these embodiments, and includes designs within a range that does not depart from the gist of the present invention.

As described above, according to the present invention, a plurality of program data received via a line which is either a communication line or a broadcast line from a broadcast station is stored in a first memory device, via a communication device from the client terminal registration process is carried out after receiving distribution application data for a program broadcast from the broadcast station, the plurality of program data is recorded on a second storage device as distribution registered data, and based on the distribution registered data stored in this second storage device, the program data stored in the first storage device is distributed via a communication device, and thereby a viewing opportunity of a desired program can be guaranteed for a client (each individual).

What is claimed is:

1. A program recording and distributing system providing:
a first storage device that stores a plurality of program data to be distributed to a client;
a second storing device that stores a plurality of distribution registration data, which is the distribution information for program data, stored in said first storage device; and
a server that carries out a recording process that receives said program data via a communication line or a broadcast line from a broadcast station and stores it in said first storage device; a distribution registration process that receives said distribution application data for a program sent from the broadcast station via a communication device from the client terminal, carries out distribution registration, and stores this in said second storage device as said distribution registration data; and a distribution process that distributes the program data stored in said first storage device via a communication device based on distribution registration data stored in said second storage device.

2. A program recording and distributing system providing:
a first storage device that stores a plurality of recording registration data, which is the recording information of the program data, distributed to a client;
a second storing device that stores a plurality program data;
a third storage device that stores a plurality of distribution registration data, which is the distribution information for program data, stored in said second storage device; and
a server that carries out a recording registration process that receives the program recording application data sent from the broadcast station via a communication device from a client terminal, carries out a registration process, and stores this in the first storage device as said recording registration data, a recording process that receives said program data from the broadcast station via either a communication line or a broadcast line and stores said received program data in said second storage device based on the recording registration data stored in said first storage device, a distribution registration process that receives said program distribution data via a communication device from a client terminal, carries out a registration process, and stores this in said third storage device as said distribution registration data, and a distribution process in which the program data stored in said second storage device is distributed via a communication device based on the distribution registration data stored in said third storage device.

3. A program recording and distributing system according to claims 1 and 2, wherein said server associates and stores the storage time and program name when the program data is stored in said recording process.

4. A program recording and distributing system according to claims 1 and 2, wherein said server periodically distributes program data stored in said distribution process.

5. A program recording and distributing method in a server that records and distributes programs broadcast from a broadcast station, wherein said program recording and distribution method comprises:
a step of storing in a first storage device a plurality of program data received via either a communication line or broadcast line from said broadcast station;
a step of receiving said distribution application data for a program via a communication device from a client terminal, carrying out a registration process, and storing this in a second storage device as distribution registration data; and
a step of distributing via a communication device program data stored in said first storage device based on the distribution registration data stored in said second storage device.

6. A program recording and distributing method in a server that records and distributes programs broadcast from a broadcast station, wherein said program recording and distributing method comprises:
a step of receiving said program recording application data via a communication device from a client terminal, carrying out a registration process, and storing this in a first storage means as recording registration data;
a step of receiving program data via either a communication line or a broadcast line from said broadcast station and storing said received program data in a second storage device based on recording registration data stored in said first storage device;
a step of receiving distribution application data for a program via a communication device from a client terminal, carrying out a registration process, and storing this in a third storage device as distribution registration data; and
a step of distributing via a communication device program data stored in said second storage device based on the distribution registration data stored in said third storage device.

7. A program recording and distributing method comprising:
a step of recording a plurality of programs broadcast from a broadcast station;
a step of receiving said distribution application program from a client;
a step of registering the received distribution applications as distribution information; and
a step of distributing said recorded programs based on the registered distribution information.

8. A program recording and distributing method comprising:
a step of receiving from a clients recording applications for programs broadcast from broadcast stations;
a step of registering the received recording applications as recording information;
a step of recording said programs based on the registered recording information;
a step of receiving distribution application for a program from a client;
a step of registering the received distribution applications as distribution information;
and a step of distributing said recorded programs based on registered distribution information.

9. A computer readable recording medium that stores a program recording and distributing program for carrying out a program recording and distribution process in a server that records and distributes broadcast programs from a broadcast station, wherein said program recording and distributing program executes on a computer:
a process for storing in a first storage device a plurality of program data via either a communication line or a broadcast line from said broadcast station;
a process for receiving said distribution application data for a program via a communication device from a client terminal, carrying a out registration process, and storing this in the second storage device as distribution registration data; and
a process for distributing via a communication device program data stored in said first storage means based on the distribution registration data stored in said second storage device.

10. A computer readable recording medium that stores a program recording and distributing program for carrying out program recording and distribution process in a server that records and distributes broadcast programs from a broadcast station, wherein said program recording and distributing program executes on a computer:
a process for receiving said program recording application data via a communication device from a client terminal, carrying out a registration process, and storing this in a first storage device as recording registration data;
a process for receiving program data via a communication line or a broadcast line from said broadcast station and storing said received program data in said second storage device based on the recording registration data stored in said first storage device;
a process for receiving distribution application data for a program via a communication device from a client terminal, carrying out registration process, and storing this in a third storage device as distribution registration data; and
a process for distributing via a communication device program data stored in said second storage device based on the distribution registration data stored in said third storage device.
